(19) United States
(12) Patent Application Publication
(10) Pub. No.: US 2015/0350441 A1
(43) Pub. Date: Dec. 3, 2015

(54) CHARITY CALL MANAGEMENT PROGRAM

(71) Applicant: LINKEDIN CORPORATION, MOUNTAIN VIEW, CA (US)

(72) Inventors: Venkata S.J.R. Bhamidipati, Fremont, CA (US); Evan Purcer, San Francisco, CA (US); Evan Brynne, Mountain View, CA (US); Thomas Jeffrey Matthews, Dublin (IE)

(73) Assignee: LINKEDIN CORPORATION, MOUNTAIN VIEW, CA (US)

(21) Appl. No.: 14/292,718

(22) Filed: May 30, 2014

(51) Int. Cl. H04M 3/523; G06Q 30/02; H04M 3/51

(52) U.S. Cl. CPC H04M 3/5232; H04M 3/5133; G06Q 30/0279

(57) ABSTRACT

Techniques for improved management of charity calling programs are described. According to various embodiments, a request from a caller to participate in a charity call program associated with a particular charitable organization is received. A recipient that is currently not assigned to a caller associated with the charity call program is identified, based on an electronic recipient call list. Contact information associated with the recipient is then provided to the caller. Thereafter, it is determined that the caller has successfully communicated with the specific recipient. The electronic recipient call list is then updated to indicate that the caller has successfully communicated with the specific recipient.

### TECHNICAL FIELD

The present application relates generally to data processing systems and, in one specific example, to techniques for improved management of charity calling programs.

### BACKGROUND

“Charity call” programs generally involve telephonically calling prior and prospective donors of a charitable and/or non-profit organization in order to solicit charitable contributions and donations for various causes associated with the organization.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the invention;

FIG. 2 is a block diagram of an example system, according to various embodiments;

FIG. 3 is a flowchart illustrating an example method, according to various embodiments;

FIG. 4 is a flowchart illustrating an example method, according to various embodiments;

FIG. 5 is a flowchart illustrating an example method, according to various embodiments;

FIG. 6 illustrates an example portion of a user interface, according to various embodiments;

FIG. 7A illustrates an example portion of a user interface, according to various embodiments;

FIG. 7B illustrates an example portion of a user interface, according to various embodiments;

FIG. 7C illustrates an example portion of a user interface, according to various embodiments;

FIG. 8 illustrates an example portion of a user interface, according to various embodiments;

FIG. 9 illustrates an example portion of a user interface, according to various embodiments;

FIG. 10 illustrates an example portion of a user interface, according to various embodiments;

FIG. 11 illustrates an example portion of a user interface, according to various embodiments;

FIG. 12 is a flowchart illustrating an example method, according to various embodiments;

FIG. 13 is a flowchart illustrating an example method, according to various embodiments;

FIG. 14 is a flowchart illustrating an example method, according to various embodiments;

FIG. 15 illustrates an example mobile device, according to various embodiments; and

FIG. 16 is a diagrammatic representation of a machine in the example form of a computer system within which a set of instructions, for causing the machine to perform any one or more of the methodologies discussed herein, may be executed.

### DETAILED DESCRIPTION

Example methods and systems for improved management of charity calling programs are described. In the following description, for purposes of explanation, numerous specific details are set forth in order to provide a thorough understanding of example embodiments. It will be evident, however, to one skilled in the art that the present invention may be practiced without these specific details.

According to various example embodiments, a charity call management system is configured to provide for improved management of charity calling programs. For example, conventional charity calling programs involve a group of callers telephonically calling prior and prospective donors of a charitable organization, in order to solicit charitable contributions and donations for various causes associated with the organization. Typically, an administrator of the program receives a “donor call list” from the organization that lists the donors to be called and their contact information. The administrator may take a photocopy of the donor call list and provide one copy to each caller. The administrator may then manually assign each caller to contact various donors in the donor call list. When a caller is able to successfully call a donor, they may mark the appropriate column in their copy of the donor call list, or they may write notes indicating that the donor could not be reached, etc. However, often there is a drawback in that each copy of the donor call list given to each caller must be returned to the administrator who must manually incorporate the information from each donor call list into a master donor call list. Moreover, in many countries, privacy requirements force the administrator to manually confirm that each of the donor call lists are returned and that they are all accounted for. Moreover, another drawback is that some donors are never called. For example, if each caller is pre-assigned to a set of donors, such as caller 1 being pre-assigned to donors #1-20, and caller 2 being pre-assigned to donors #21-40, then by the end of the charity call program, some of the donors have not been contacted if the volunteer pre-assigned to that donor has not had time to call them. Further, another drawback is that some donors are called more than once. For example, if caller 1 starts calling donor #1 and works their way down through the list of donors, while caller 2 starts calling donor #50 and works their way in reverse up through the list of donors, then caller 1 and caller 2 may meet and call the same donor(s), depending on how efficient they are.

Accordingly, a charity call management system described herein provides a user interface (such as a web-based user interface that may be accessed on a web browser via the internet, or a mobile-application user interface that may be accessed on a mobile device) that enables an administrator to easily and efficiently manage a charity call program. For example, a donor call list may be received from a charitable organization, where the donor call list identifies donors to be called (e.g., donors that have previously donated to the charitable organization), their contact information, and any miscellaneous information about the donor (e.g., specific causes of the charitable organization that they have been involved with). The system may then generate an electronic donor call list that includes the aforementioned information. For example, the electronic donor call list may correspond to a series of electronic records in a database, data table, or similar data structure, where each record corresponds to a particular donor and includes various fields of data associated with each donor, such as name, contact information, specific causes of the charitable organization that they have been involved with (e.g., indicating that they have previously donated to that cause, or that they may donate to that cause, etc.), a current status of the calls to the donor in the current charity call program (e.g., assigned to a volunteer caller, not assigned to a volunteer caller, call completed successfully, donor could not be contacted, etc.), and a notes field for storing miscellaneous notes.

Accordingly, any user that is interested in being a volunteer caller in a charity calling program may access a user interface associated with the system (e.g., by accessing a mobile application associated with the system on their mobile device, or by accessing a webpage URL (Uniform Resource Locator) associated with the system). The system may then automatically select a donor in the donor list and assign it to the volunteer caller. For example, in some embodiments, the system may generate a queue of donors based on the electronic donor call list, where the queue may include information identifying whether each donor in the queue has been assigned to any volunteer caller as of the present time. For example, the queue may correspond to a database, data structure, or data table including plurality of records associated with a plurality of donors, where each record includes a field indicating whether the corresponding donor is currently assigned to a volunteer caller or not. The system may then select the first donor in the queue not marked as being assigned to any volunteer caller, and assign that donor to the current volunteer caller requesting to participate in the program, and then change the queue information and/or electronic donor call list to indicate that that donor is currently assigned to the volunteer caller. Thus, when a subsequent volunteer caller logs in, the system will identify the next donor in the queue that is not marked as being assigned to any volunteer caller, and then assign that next donor to the subsequent volunteer caller, and mark that next donor as being assigned to the subsequent volunteer caller, and so on. In this way, each donor is assigned to a single volunteer caller, and there are no duplicate calls to a single donor. Put another way, the system ensures that each donor in the queue for a particular charity is specifically assigned to a separate caller, to ensure that two or more callers do not get the same donor to call. The system accomplishes this by marking each donor in the queue to indicate whether they are currently assigned to a caller or not.

After a donor is assigned to a volunteer caller, the system may display a user interface that includes the donor's name, contact information (e.g., phone number), and talking points customized for the donor (e.g., if the donor has previously donated to hurricane relief in Indonesia, then talking points describing about how donations have helped that cause may be displayed). The user interface may include a notes section to allow the caller to enter various notes (e.g., “donor could not be reached”, “donor said not to call them anymore”, “donor said to call them back in a month”, “donor said they are changing their number to XYZ”, “donor said they are interested in these causes . . . ”, and so on). Any notes entered by the volunteer caller are then automatically incorporated into the electronic donor call list maintained by the system (e.g., incorporated into the appropriate field in the record associated with that donor). The user interface may also allow the caller to update the contact information of the donor. For example, a “change phone number” or “change address” button may be displayed next to the donor's phone number or address, respectively, and if the volunteer caller selects this button, they can enter the donor's new phone number or address. Any updated contact information may then be automatically incorporated into the electronic donor call list maintained by the system (e.g., in the appropriate field in the record associated with that donor). The user interface may include a button labelled such as “Call Complete” that, when selected, automatically updates the electronic donor call list to indicate that the call to the donor was completed successfully. The user interface may include a button labelled such as “Donor could not be reached” that, when selected, automatically updates the electronic donor call list to indicate that the donor could not be reached successfully. At the end of the charity call program, the updated electronic donor call list (indicating all the donors that have and have not been successfully reached and updating contact information) may be transmitted to the charitable organization.

In some embodiments, the system may handle multiple charity call programs associated with multiple charitable organizations. For example, when a volunteer caller accesses the system, the system may display a user interface allowing the volunteer caller to select a charitable organization (e.g., the Salvation Army®) from a number of options, or to search for charitable organizations associated with particular causes (e.g., the volunteer caller can type “clean drinking water in Africa” and select an organization from the matching results). The charity call management system may then access the appropriate electronic donor call list associated with the selected charitable organization.

In some embodiments, each particular charitable organization (e.g., the Salvation Army®) may be associated with multiple causes (e.g., clean drinking water in Africa, hurricane relief in Indonesia, etc.). For each particular cause associated with a charitable organization, the system may generate an appropriate queue identifying donors associated with the particular cause, in order to assign volunteer callers to these donors. For example, the system may access the electronic donor call list associated with that charitable organization that describes the causes each donor to that organization is associated with (e.g., indicating whether they have previously donated to that cause, or whether they may donate to that cause, etc.). The system may then generate a filtered queue that includes only the donors to that organization that are associated with a particular cause. In some embodiments, after a volunteer caller selects a charitable organization to conduct calls on behalf of, the system may display various causes associated with that charitable organization, and if the volunteer caller selects a particular cause, the charity call management system may access or generate the queue of donors associated with that particular cause (as described above) and assign the first donor in that queue to the volunteer caller.

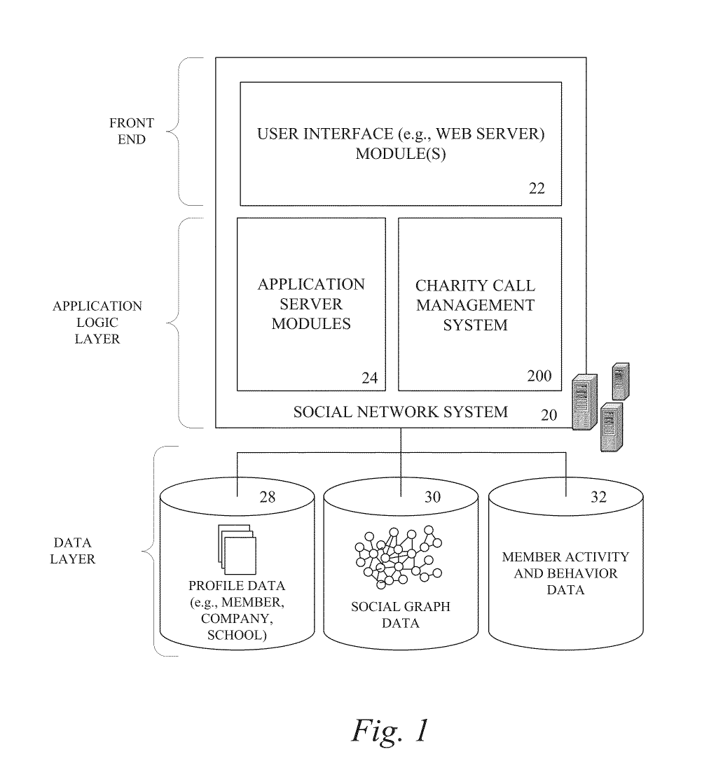

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bilateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

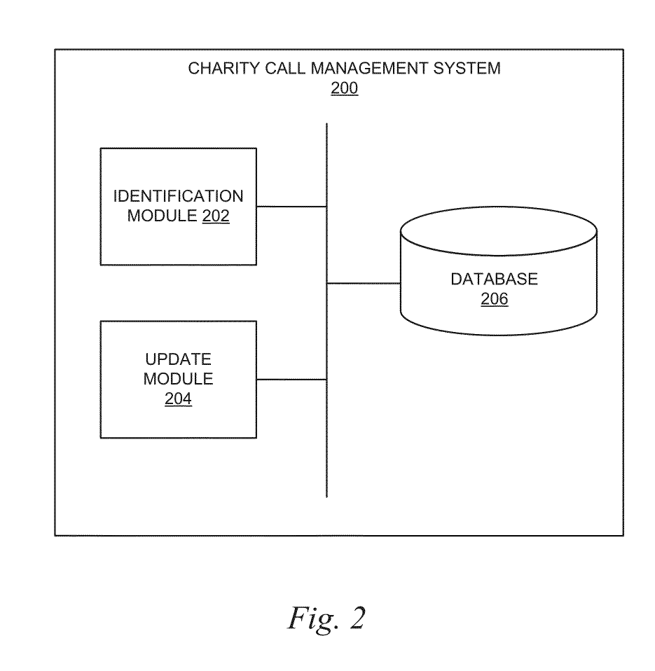

With some embodiments, the social network system 20 includes what is generally referred to herein as a charity call management system 200. The charity call management system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content-hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phones, or tablet computing devices) having a mobile operating system.

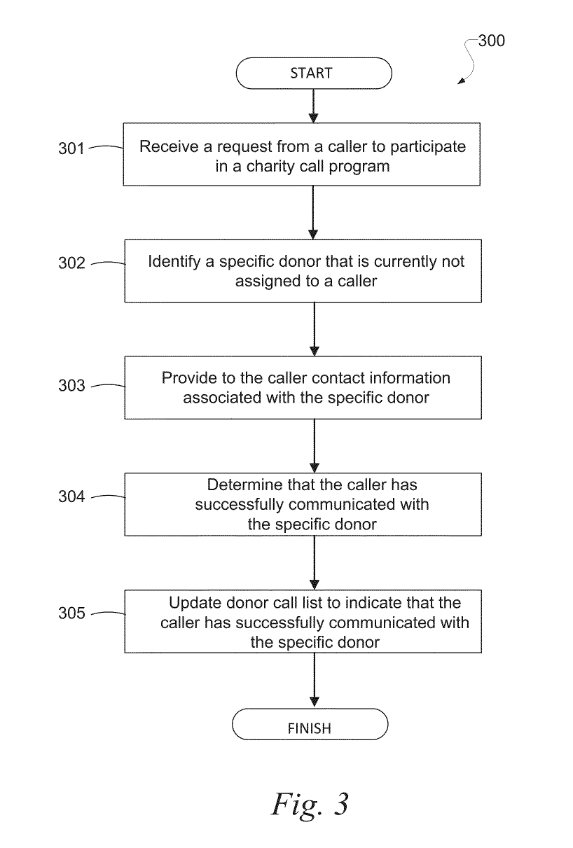

Turning now to FIG. 2, a charity call management system 200 includes an identification module 202, an update module 204, and a database 206. The modules of the charity call management system 200 may be implemented on or executed by a single device, such as a charity call management device, or on separate devices interconnected via a network. The aforementioned charity call management device may be, for example, one or more client machines or application servers. The operation of each of the aforementioned modules of the charity call management system 200 will now be described in greater detail in conjunction with FIG. 3.

FIG. 3 is a flowchart illustrating an example method 300, according to various example embodiments. The method 300 may be performed at least in part by, for example, the charity call management system 200 illustrated in FIG. 2 (or an apparatus having similar modules, such as one or more client machines or application servers). In operation 301 in FIG. 3, the identification module 202 receives, via one or more user interfaces, a request from a volunteer caller (or, more generally, any caller, including a paid caller, etc.) to participate in a charity call program associated with a particular charitable organization. For example, in some embodiments, the receiving of the request from the volunteer caller (operation 301) may comprise displaying, via one or more user interfaces, a list of the one or more charitable organizations, and receiving, via the one or more user interfaces, a user selection of the charitable organization from the one or more charitable organizations. In some embodiments, the one or more user interfaces are accessible via a website. In some embodiments, the one or more user interfaces are accessible via a mobile application installed on a mobile device.

In operation 302 in FIG. 3, the identification module 202 identifies, based on an electronic donor call list (or, more generally, an electronic recipient call list) associated with the charitable organization that identifies a plurality of donors (or, more generally, a plurality of call recipients), a specific donor that is currently not assigned to a volunteer caller associated with the charity call program. In operation 303 in FIG. 3, the identification module 202 provides to the volunteer caller, via one or more user interfaces, contact information associated with the specific donor. In operation 304 in FIG. 3, the update module 204 determines that the volunteer caller has successfully communicated with the specific donor. For example, in some embodiments, the update module 204 may detect or receive, via one or more user interfaces, a user selection of a user interface element indicating that the volunteer caller has successfully communicated with the specific donor.

In operation 305 in FIG. 3, the update module 204 updates an electronic donor call list to indicate that the volunteer caller has successfully communicated with the specific donor. In some embodiments, the updated electronic donor call list includes a plurality of records associated with each of the plurality of donors, each of the records indicating current contact information for the corresponding donor and whether the corresponding donor has been successfully communicated with during the charity call program. Although not illustrated in FIG. 3, after updating the donor call list in operation 305, the update module 204 may transmit the updated donor call list to an e-mail address, chat address, SMS (Short Message Service) address, contact address, storage location (e.g., Uniform Resource Locator), etc., associated with the charitable organization.

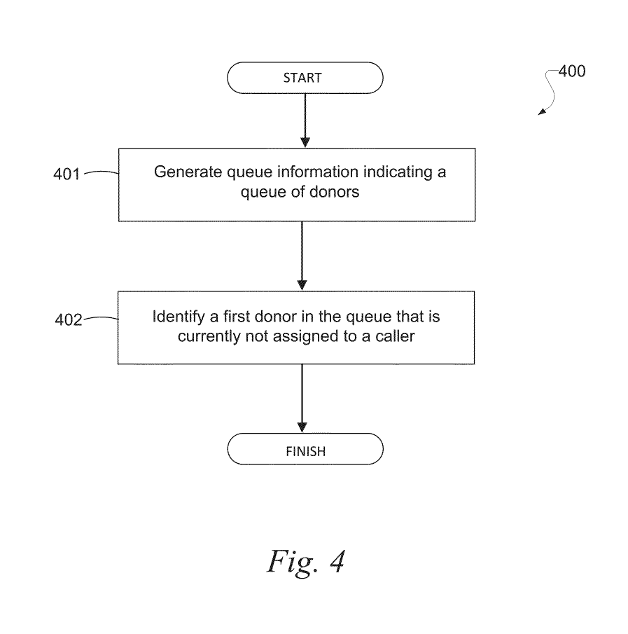

FIG. 4 is a flowchart illustrating an example method 400 consistent with various embodiments described above. In some embodiments, the method 400 may be performed in conjunction with the operation 302 in FIG. 3. The method 400 may be performed at least in part by, for example, the charity call management system 200 illustrated in FIG. 2 (or an apparatus having similar modules, such as one or more client machines or application servers). In operation 401, the identification module 202 generates, based on an electronic donor call list, queue information indicating a queue of donors and indicating whether each donor in the queue is currently assigned to a volunteer caller associated with a charity call program. In operation 402, the identification module 202 identifies, as a specific donor to be assigned to a volunteer caller, a first donor in the queue that is currently not assigned to any volunteer caller associated with the charity call program. It is contemplated that the operations of method 400 may incorporate any of the other features disclosed herein. Various operations in the method 400 may be omitted or rearranged, as necessary.

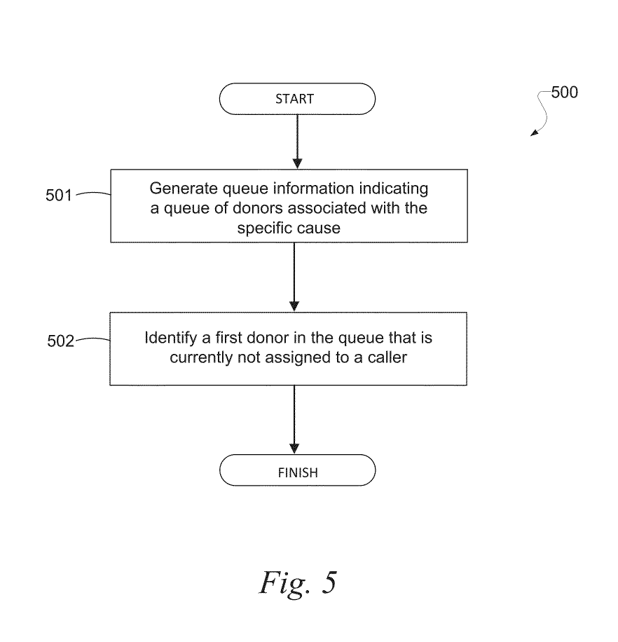

FIG. 5 is a flowchart illustrating an example method 500, consistent with various embodiments described above. In some embodiments, the method 500 may be performed in conjunction with the operation 302 in FIG. 3. The method 500 may be performed at least in part by, for example, the charity call management system 200 illustrated in FIG. 2 (or an apparatus having similar modules, such as one or more client machines or application servers). In operation 501, the identification module 202 generates, based on an electronic donor call list, queue information including a queue of donors associated with a specific cause of a charitable organization, and indicating whether each donor is currently assigned to a volunteer caller associated with the charity call program. The electronic donor call list may indicate one or more known charitable causes associated with each of various donors. In operation 502, the identification module 202 identifies, as a specific donor to be assigned to a volunteer caller, a first donor in the queue that is currently not assigned to any volunteer caller associated with the charity call program. It is contemplated that the operations of method 500 may incorporate any of the other features disclosed herein. Various operations in the method 500 may be omitted or rearranged, as necessary.

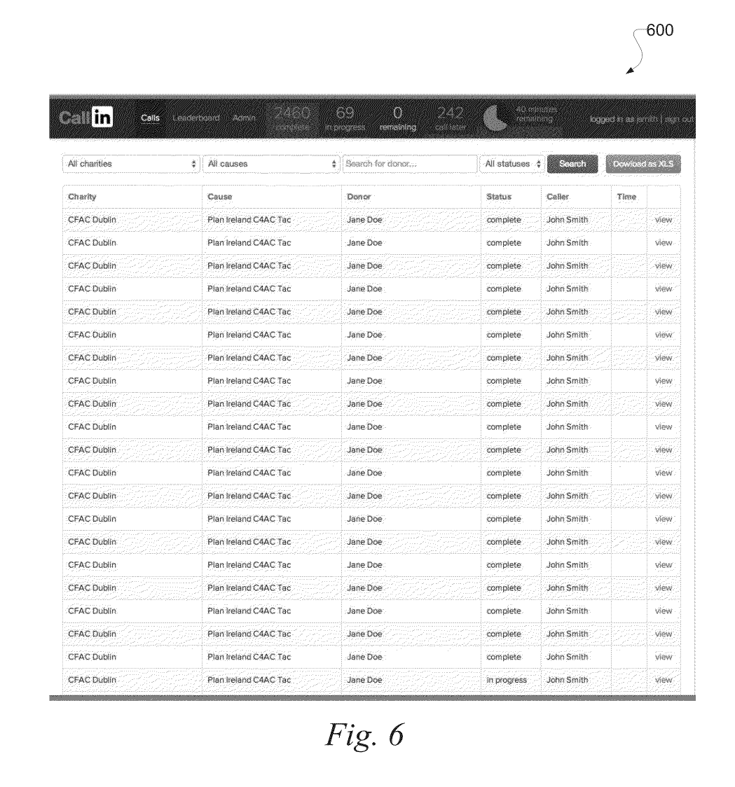

FIG. 6 illustrates an example user interface 600 displayed by the charity call management system 200 that enables a user (e.g., an administrator or volunteer caller of a charity call program) to view information corresponding to an electronic donor call list. For example, the user interface 600 displays multiple records corresponding to multiple donors, where each record identifies a first name and last name of the donor, contact information, current status (e.g., unclaimed (or unassigned), in progress (or assigned), complete (or call successful), call later (or call unsuccessful), etc.), charities and causes associated with the donor, a volunteer caller assigned to the donor (if any), patron/donor details (e.g., location). The user interface 600 also allows the user to enter keywords and to perform a search for a donor (as well as fields for filtering charities, causes, and statuses of the search results, etc.).

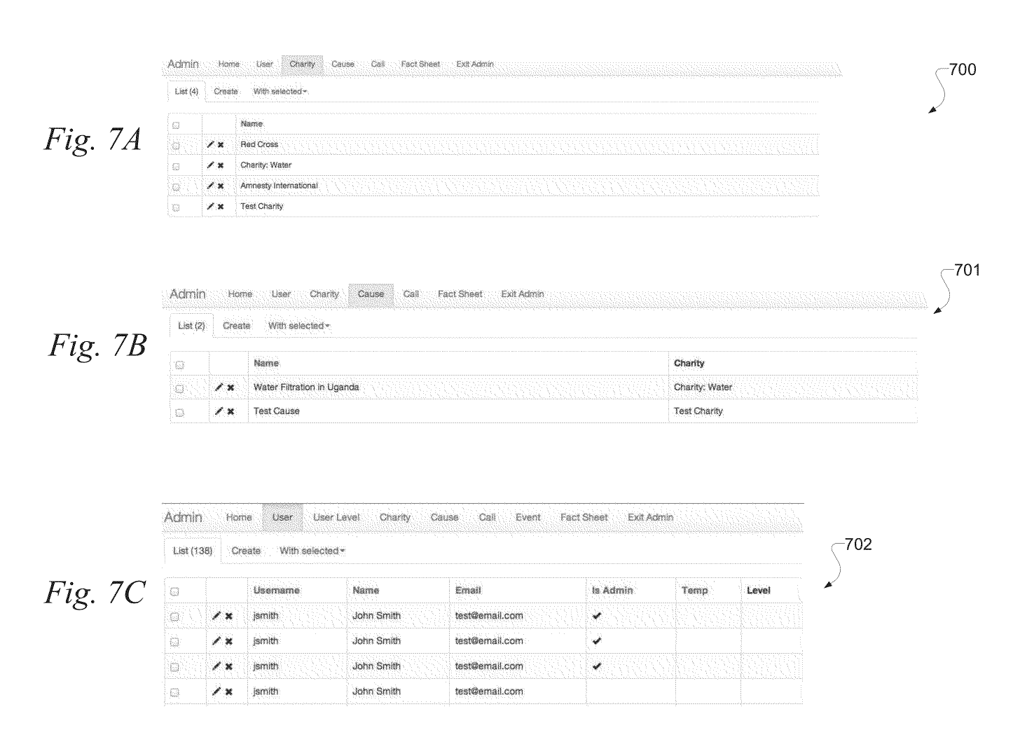

FIG. 7A displays an example user interface 700 displayed by the charity call management system 200 that enables a user (e.g., an administrator or volunteer caller of a charity call program) to view and search for charities. For example, when the user clicks on the “Charity” tab in the user interface 700, a list of charities is displayed.

FIG. 7B displays an example user interface 701 displayed by the charity call management system 200 that enables a user (e.g., an administrator or volunteer caller of a charity call program) to view and search for a cause. For example, when the user clicks on the “Cause” tab in the user interface 701, a list of causes and associated charities is displayed.

FIG. 7C displays an example user interface 702 displayed by the charity call management system 200 that enables a user (e.g., an administrator or volunteer caller of a charity call program) to view and search for volunteer callers. For example, when the user clicks on the “User” tab in the user interface 702, a list of volunteer causes is displayed.

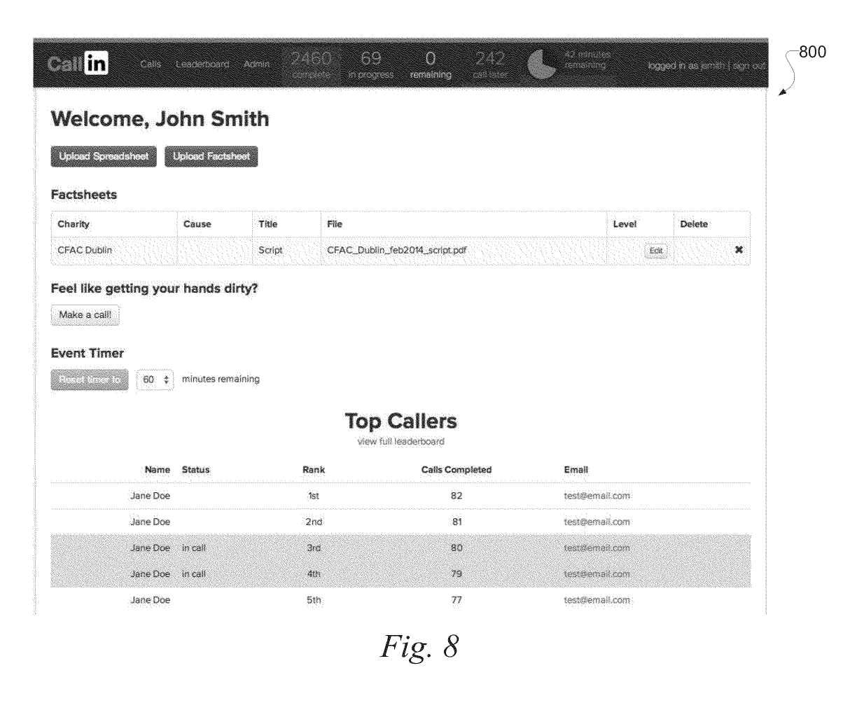

FIG. 8 illustrates an example user interface 800 displayed by the charity call management system 200 that enables a user (e.g., an administrator or volunteer caller of a charity call program) to upload a donor call list (e.g., via the “Upload Spreadsheet” button), and to upload talking points documents or “factsheets” for various charities and/or causes (e.g., via the “Upload Factsheet” button), and view already uploaded factsheets. The user interface 800 allows the user to call a donor by clicking on the “Make a call!” button, to set an event timer for the charity call program, and to view top callers by performance (e.g., based on calls completed and associated rank).

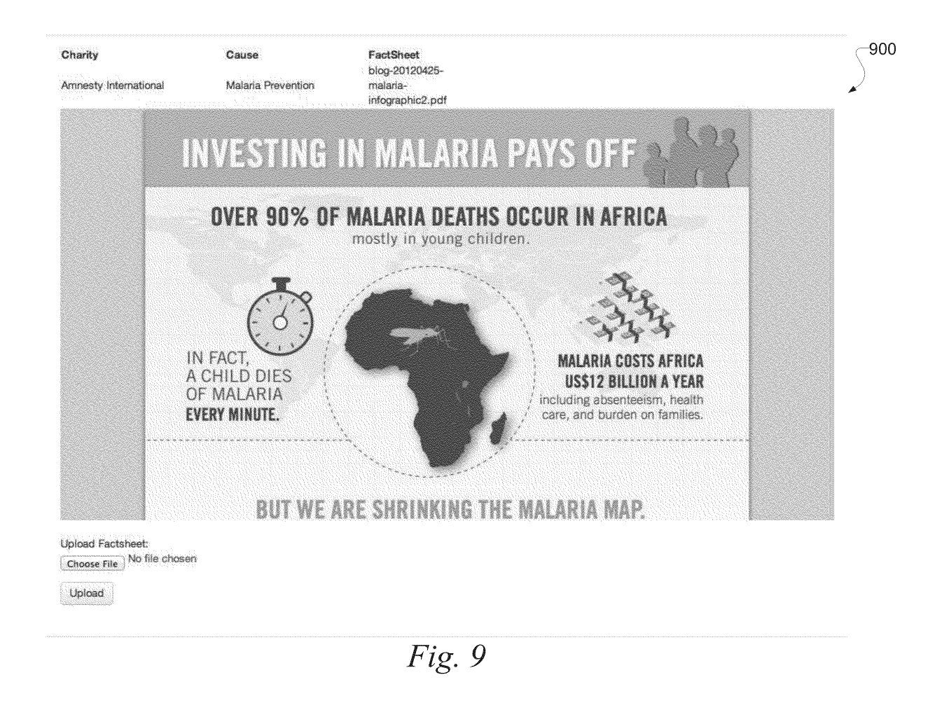

FIG. 9 illustrates an example user interface 900 displayed by the charity call management system 200 that enables a user (e.g., an administrator or volunteer caller of a charity call program) to upload a talking points document (e.g., a PDF (Portable Document Format) file) to the charity call management system 200.

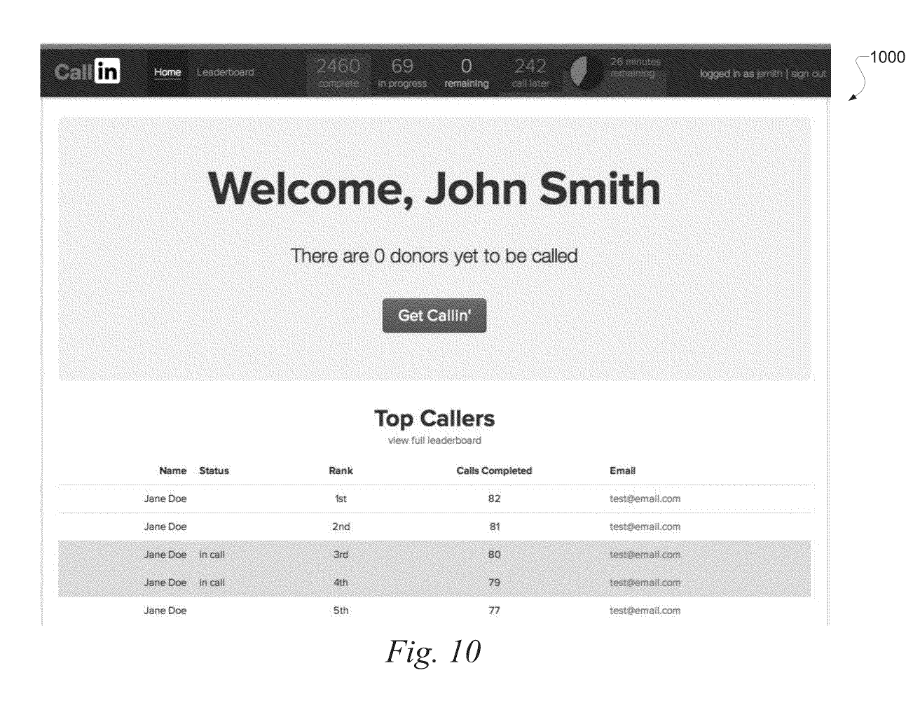

FIG. 10 illustrates an example user interface 1000 that may be displayed to a volunteer caller that accesses the charity call management system 200. The user interface 1000 allows the volunteer to call a donor by clicking “Get Callin'”, and displays a summary of relevant information (e.g., current calls in progress that are already assigned to the volunteer caller, and past donor calls completed by the volunteer caller).

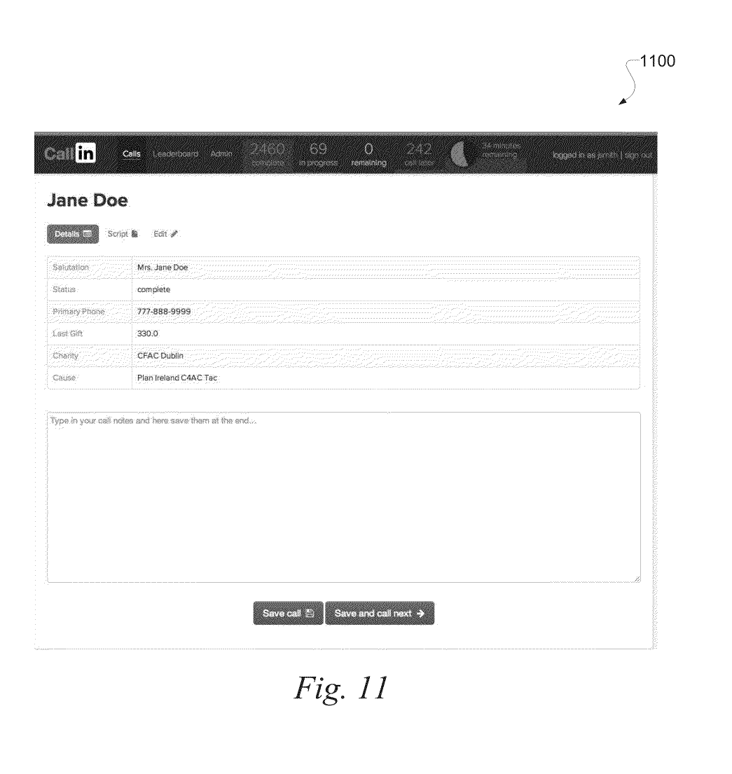

FIG. 11 illustrates an example user interface 1100 displayed by the charity call management system 200 that enables a user (e.g., a volunteer caller) to view information on a donor that is assigned to them for calling. The user interface 1100 may be displayed after, for example, the user clicks on the “Get Callin'” button in the user interface 1000 in FIG. 10 or the “Make a call!” Button in the user interface 800 in FIG. 8. In particular, the user interface 1100 displays call “Details” including the donor name, associated charity and cause, primary phone number, status of call thereto, last gift, etc. The user interface 1100 also includes a notes section as described above, and a fact sheet or talking points section accessible via the “Script” button (e.g., where the user can view the fact sheet illustrated in FIG. 9). A user can select “Save call” or “Save and call next” to indicate that the call was successful.

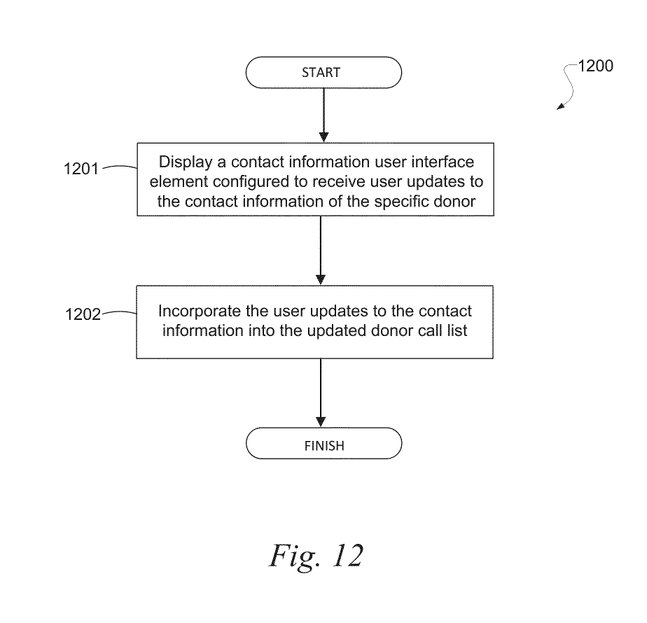

FIG. 12 is a flowchart illustrating an example method 1200, consistent with various embodiments described above. The method 1200 may be performed at least in part by, for example, the charity call management system 200 illustrated in FIG. 2 (or an apparatus having similar modules, such as one or more client machines or application servers). In operation 1201, the update module 204 displays, via one or more user interfaces, a contact information user interface element configured to receive user updates to contact information associated with a specific donor. In operation 1202, the update module 204 incorporates the user updates to the contact information into an updated donor call list. It is contemplated that the operations of method 1200 may incorporate any of the other features disclosed herein. Various operations in the method 1200 may be omitted or rearranged, as necessary.

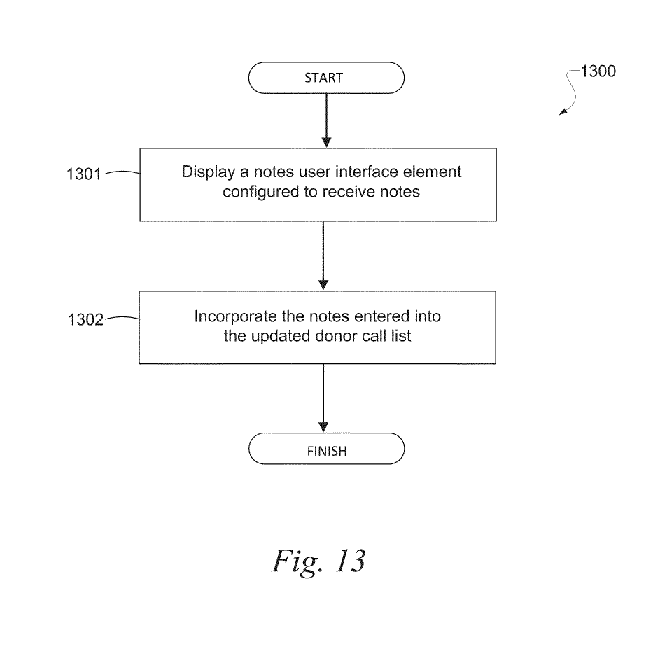

FIG. 13 is a flowchart illustrating an example method 1300, consistent with various embodiments described above. The method 1300 may be performed at least in part by, for example, the charity call management system 200 illustrated in FIG. 2 (or an apparatus having similar modules, such as one or more client machines or application servers). In operation 1301, the update module 204 displays, via one or more user interfaces, a notes user interface element configured to receive notes entered by a volunteer caller. In operation 1302, the update module 204 incorporates the notes entered by the volunteer caller into an updated donor call list. It is contemplated that the operations of method 1300 may incorporate any of the other features disclosed herein. Various operations in the method 1300 may be omitted or rearranged, as necessary.

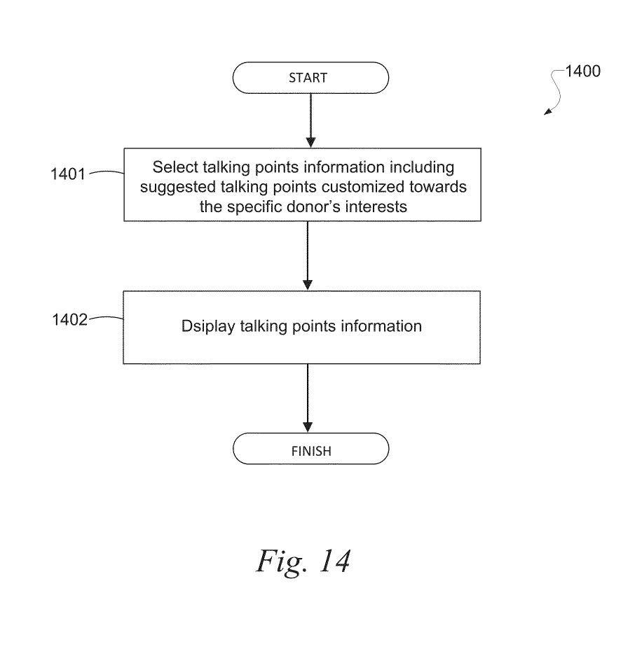

FIG. 14 is a flowchart illustrating an example method 1400, consistent with various embodiments described above. The method 1400 may be performed at least in part by, for example, the charity call management system 200 illustrated in FIG. 2 (or an apparatus having similar modules, such as one or more client machines or application servers). In operation 1401, the identification module 202 selects talking points information including suggested talking points customized towards a specific donor's interests. For example, the identification module 202 may select the talking points information by: 1) identifying, based on a donor call list, a charitable cause associated with the specific donor, the donor call list indicating one or more known charitable causes associated with each of the donors; 2) determining that a particular instance of talking points information (e.g., stored in a database such as database 206) is associated with the charitable cause; and 3) accessing the talking points information associated with the charitable cause (e.g., from a database such as database 206). In operation 1402, the identification module 202 displays, via one or more user interfaces, the talking points information that includes the suggested talking points customized towards the specific donor's interests. It is contemplated that the operations of method 1400 may incorporate any of the other features disclosed herein. Various operations in the method 1400 may be omitted or rearranged, as necessary.

While various embodiments herein refer to “charitable organizations”, it is understood that the techniques described herein are applicable to any type of organization, including charitable organizations, non-profit organizations, non-governmental organizations, government organizations, for-profit businesses, private enterprises, clubs, and so on.

Various embodiments herein are applicable to any type of activity involving assigning communication tasks (e.g., telephone calls, email communications) to users, including for-profit activities, sales calls, telemarketer calls, etc.

### Example Mobile Device

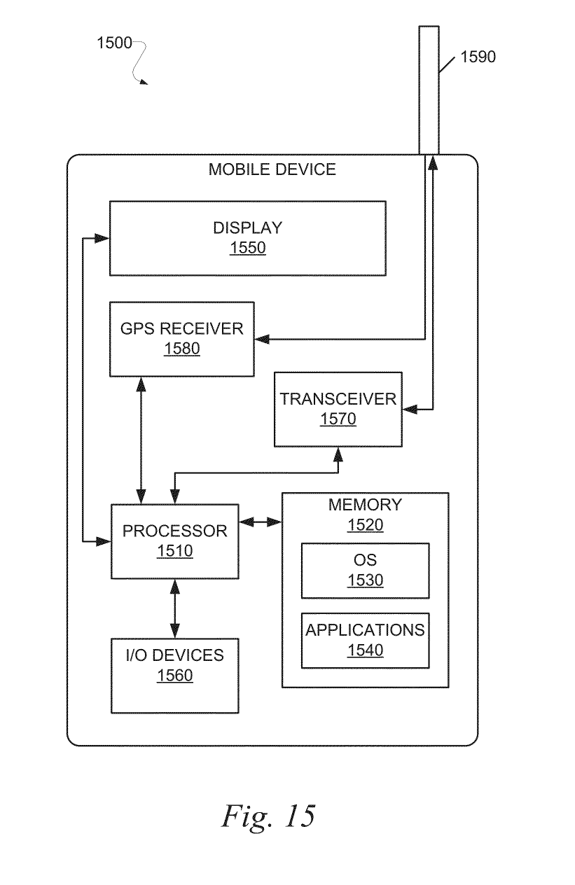

FIG. 15 is a block diagram illustrating the mobile device 1500, according to an example embodiment. The mobile device 1500 may correspond to, for example, one or more client machines or application servers. One or more of the modules of the system 200 illustrated in FIG. 2 may be implemented on or executed by the mobile device 1500. The mobile device 1500 may include a processor 1510. The processor 1510 may be any of a variety of different types of commercially available processors suitable for mobile devices (for example, an XScale architecture microprocessor, a Microprocessor without Interlocked Pipeline Stages (MIPS) architecture processor, or another type of processor). A memory 1520, such as a Random Access Memory (RAM), a Flash memory, or other type of memory, is typically accessible to the processor 1510. The memory 1520 may be adapted to store an operating system (OS) 1530, as well as application programs 1540, such as a mobile location enabled application that may provide location based services to a user. The processor 1510 may be coupled, either directly or via appropriate intermediary hardware, to a display 1550 and to one or more input/output (I/O) devices 1560, such as a keypad, a touch panel sensor, a microphone, and the like. Similarly, in some embodiments, the processor 1510 may be coupled to a transceiver 1570 that interfaces with an antenna 1590. The transceiver 1570 may be configured to both transmit and receive cellular network signals, wireless data signals, or other types of signals via the antenna 1590, depending on the nature of the mobile device 1500. Further, in some configurations, a GPS receiver 1580 may also make use of the antenna 1590 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field-programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field-programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

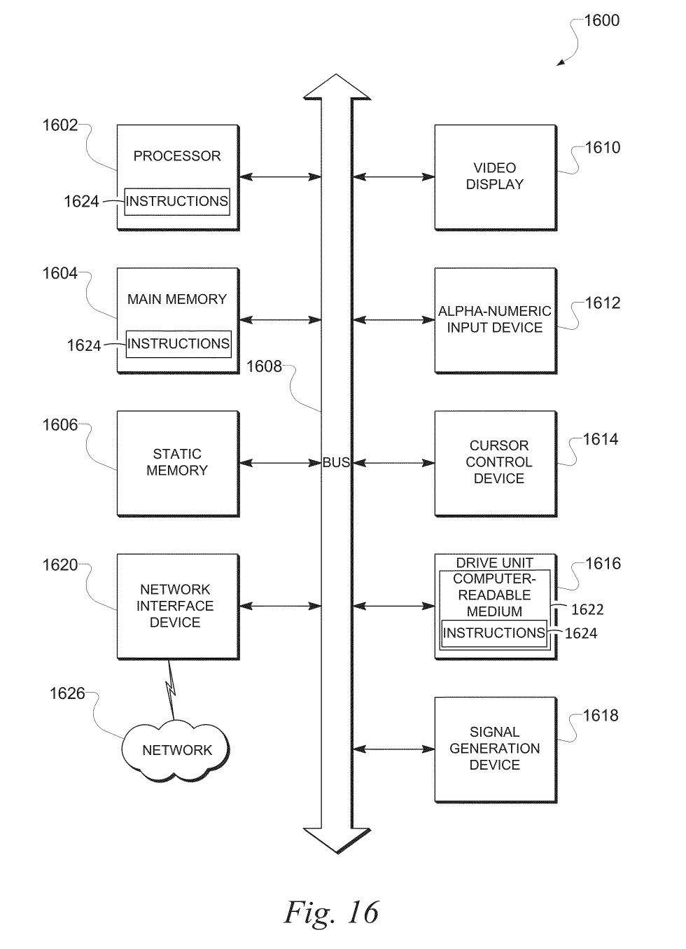

FIG. 16 is a block diagram of machine in the example form of a computer system 1600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard or a touch-sensitive display screen), a user interface (UI) navigation device 1614 (e.g., a mouse), a disk drive unit 1616, a signal generation device 1618 (e.g., a speaker) and a network interface device 1620.

### Machine-Readable Medium

The disk drive unit 1616 includes a machine-readable medium 1622 on which is stored one or more sets of instructions and data structures (e.g., software) 1624 embodying or utilized by any one or more of the methodologies or functions described herein. The instructions 1624 may also reside, completely or at least partially, within the main memory 1604 and/or within the processor 1602 during execution thereof by the computer system 1600, the main memory 1604 and the processor 1602 also constituting machine-readable media.

While the machine-readable medium 1622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM) and Digital Versatile Disc Read-Only Memory (DVD-ROM) disks.

### Transmission Medium

The instructions 1624 may further be transmitted or received over a communications network 1626 using a transmission medium. The instructions 1624 may be transmitted using the network interface device 1620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
receiving, via one or more user interfaces, a request from a caller to participate in a charity call program associated with a particular charitable organization;
accessing, from a database storing a plurality of electronic call lists associated with a plurality of charitable organizations, an electronic call list associated with the charitable organization that identifies a plurality of call recipients;
identifying, using one or more processors, based on the accessed electronic call list associated with the charitable organization, a specific call recipient from the plurality of call recipients that is currently not assigned to a caller associated with the charity call program;
providing to the caller, via the one or more user interfaces, a prompt indicating that the specific call recipient is currently not assigned to a caller and contact information associated with the specific call recipient;
determining that the caller has successfully communicated with the specific call recipient; and
updating, using the one or more processors, the electronic call list to indicate that the caller has successfully communicated with the specific call recipient.

2. The method of claim 1, wherein the updated electronic call list includes a plurality of records associated with each of the plurality of call recipients, each of the records indicating current contact information for the corresponding call recipient and whether the corresponding call recipient has been successfully communicated with during the charity call program.

3. The method of claim 1, wherein the identifying of the specific call recipient further comprises:
generating, based on the electronic call list, queue information indicating a queue of call recipients and indicating whether each call recipient in the queue is currently assigned to a caller associated with the charity call program; and
identifying, as the specific call recipient, a first call recipient in the queue that is currently not assigned to a caller associated with the charity call program.

4. The method of claim 1, further comprising displaying, via the one or more user interfaces, a contact information user interface element configured to receive user updates to the contact information associated with the specific call recipient.

5. The method of claim 4, further comprising:
incorporating the user updates to the contact information into the updated call list.

6. The method of claim 1, further comprising displaying, via the one or more user interfaces, a notes user interface element configured to receive notes entered by the caller.

7. The method of claim 6, further comprising:
incorporating the notes entered by the caller into the updated call list.

8. The method of claim 1, further comprising displaying, via the one or more user interfaces, talking points information including suggested talking points customized towards interests of the specific call recipient.

9. The method of claim 8, further comprising selecting the talking points information by:
identifying, based on the call list, a charitable cause associated with the specific call recipient, the call list indicating one or more known charitable causes associated with each of the call recipients;
determining that the talking points information is associated with the charitable cause; and
accessing the talking points information associated with the charitable cause from a database.

10. The method of claim 1, wherein the determining that the caller has successfully communicated with the specific call recipient further comprises:
receiving, via the one or more user interfaces, a user selection of a user interface element indicating that the caller has successfully communicated with the specific call recipient.

11. The method of claim 1, wherein the receiving of the request from the caller further comprises:
displaying, via the one or more user interfaces, a list of the one or more charitable organizations; and
receiving, via the one or more user interfaces, a user selection of the charitable organization from the one or more charitable organizations.

12. The method of claim 1, wherein the receiving of the request from the caller further comprises:
displaying, via the one or more user interfaces, a list of the one or more causes associated with the charitable organization; and
receiving, via the one or more user interfaces, a user selection of a specific cause from the one or more causes.

13. The method of claim 8, wherein the identifying of the specific call recipient further comprises:
generating, based on the electronic call list, queue information including a queue of call recipients associated with the specific cause and indicating whether each call recipient is currently assigned to a caller associated with the charity call program, the electronic call list indicating one or more known charitable causes associated with each of the call recipients; and
identifying, as the specific call recipient, a first call recipient in the queue that is currently not assigned to a caller associated with the charity call program.

14. The method of claim 1, further comprising:
transmitting the updated call list to an e-mail address associated with the charitable organization.

15. The method of claim 1, wherein the one or more user interfaces are accessible via a website.

16. The method of claim 1, wherein the one or more user interfaces are accessible via a mobile application installed on a mobile device.

17. A system comprising:
a processor;
a memory device holding an instruction set executable on the processor to cause the system to perform operations comprising:
receiving, via one or more user interfaces, a request from a caller to participate in a charity call program associated with a particular charitable organization;
accessing, from a database storing a plurality of electronic call lists associated with a plurality of charitable organizations, an electronic call list associated with the charitable organization that identifies a plurality of call recipients;
identifying, based on the accessed electronic call list associated with the charitable organization, a specific call recipient from the plurality of call recipients that is currently not assigned to a caller associated with the charity call program;
providing to the caller, via the one or more user interfaces, a prompt indicating that the specific call recipient is currently not assigned to a caller and contact information associated with the specific call recipient;
determining that the caller has successfully communicated with the specific call recipient; and
updating the electronic call list to indicate that the caller has successfully communicated with the specific call recipient.

18. The system of claim 17, wherein the updated electronic call list includes a plurality of records associated with each of the plurality of call recipients, each of the records indicating current contact information for the corresponding call recipient and whether the corresponding call recipient has been successfully communicated with during the charity call program.

19. A non-transitory machine-readable storage medium comprising instructions that, when executed by one or more processors of a machine, cause the machine to perform operations comprising:
receiving, via one or more user interfaces, a request from a caller to participate in a charity call program associated with a particular charitable organization;
accessing, from a database storing a plurality of electronic call lists associated with a plurality of charitable organizations, an electronic call list associated with the charitable organization that identifies a plurality of call recipients;
identify, based on the accessed electronic call list associated with the charitable organization, a specific call recipient from the plurality of call recipients that is currently not assigned to a caller associated with the charity call program;
providing to the caller, via the one or more user interfaces, a prompt indicating that the specific call recipient is currently not assigned to a caller and contact information associated with the specific call recipient;
determining that the caller has successfully communicated with the specific call recipient; and
updating the electronic call list to indicate that the caller has successfully communicated with the specific call recipient.

20. The storage medium of claim 19, wherein the updated electronic call list includes a plurality of records associated with each of the plurality of call recipients, each of the records indicating current contact information for the corresponding call recipient and whether the corresponding call recipient has been successfully communicated with during the charity call program.
